(19) United States
(12) Patent Application Publication
(10) Pub. No.: US 2021/0050621 A1
(43) Pub. Date: Feb. 18, 2021

(54) Solid Electrolyte Material for an Electrochemical Secondary Cell

(71) Applicant: Bayerische Motoren Werke Aktiengesellschaft, Muenchen (DE)

(72) Inventor: Thomas WOEHRLE, Muenchen (DE)

(21) Appl. No.: 16/964,415

(22) PCT Filed: Mar. 20, 2019
(86) PCT No.: PCT/EP2019/056908

§ 371 Date: Jul. 23, 2020

(30) Foreign Application Priority Data
Apr. 11, 2018 (DE) 10 2018 205 483.5

(51) Int. Cl. H01M 10/0562; H01M 4/04; H01M 4/139; H01M 4/62; H01M 10/0525

(52) U.S. Cl. CPC H01M 10/0562; H01M 4/0421; H01M 4/0471; H01M 2004/021; H01M 4/139; H01M 4/625; H01M 10/0525; H01M 4/043

(57) ABSTRACT

An electrically non-conductive solid electrolyte material is provided for an electrochemical secondary cell, the material has pores.

### BACKGROUND AND SUMMARY OF THE INVENTION

The invention relates to an electrically nonconductive solid electrolyte material for a secondary electrochemical cell, a secondary electrochemical cell, and also a process for producing an electrode for a secondary electrochemical cell.

Solid separators for gas diffusion electrodes, in which the solid separator material has through-channels, are known in the art (see document EP 1345280 A1). In addition, solid electrolytes which conduct lithium (Li) ions and can also be used as separator are known. The document “All Solid-State Battery” by W. Weppner in Secondary Batteries—Lithium Rechargeable System, 2009, Elsevier, discloses a layer-like structure of an Li ion battery having a solid electrolyte material which conducts lithium ions as separator which is prepared by means of sputtering or vapor deposition techniques.

It is an object of the invention to describe an improved electrically nonconductive solid electrolyte material for a secondary electrochemical cell, an improved secondary electrochemical cell and also an improved process for producing an electrode for a secondary electrochemical cell.

This object is achieved by an electrically nonconductive solid electrolyte material, by a secondary electrochemical cell, and also by a process for producing an electrode for a secondary electrochemical cell according to the invention. Advantageous embodiments and further developments of the invention are provided.

According to the invention, the electrically nonconductive solid electrolyte material for a secondary electrochemical cell has pores.

Pores can be connected to one another, but continuous channels through the solid electrolyte material which are formed by pores are optional. A preferred diameter of a pore is from 10 nm to 50 μm, with a range from 800 nm to 30 μm being particularly advantageous for use in secondary electrochemical cells, such as Li ion cells.

According to an embodiment of the invention, an electrode for a secondary electrochemical cell includes such an electrically nonconductive solid electrolyte material and an active material, wherein particles of the active material at least partly fill the pores of a first partial number of the pores which are present in a first section of the electrically nonconductive solid electrolyte material and the pores which are present in a second section of the electrically nonconductive solid electrolyte material are unfilled.

This means that not all pores but only pores in a particular section, namely, in the first section, of the solid electrolyte material are filled with particles of the active material. The pores in the other section, namely, the second section, of the solid electrolyte material can be unfilled. In this context, unfilled means that these pores are loaded with a gaseous medium, e.g., the noble gas argon. The second section in which the unfilled pores are present thus has ion-conducting and electrically nonconductive properties. The term “ion-conducting property” and the term “electrically nonconductive property” relates to the classification of these terms with which a person skilled in the field of electrochemical energy storage technology will be familiar. Here, the electrolyte typically has (Li) ion-conducting properties and the separator has electrically nonconductive properties.

The first section of the solid electrolyte material having the partial number of pores which are filled with particles of the active material has electrically conducting properties since particles of the active material, which is electrically conducting, are electrically conducting connected to one another in this region. In order to optionally reinforce the electrically conducting property of the active material, conductive carbon black and/or conductive graphite can have been added to the active material.

In addition, it is advantageous for the electrode also to contain conductive carbon black (and/or conductive graphite) and particles of conductive carbon black to at least partly fill the pores of a second partial number of pores which are present in the first section of the electrically nonconductive solid electrolyte material and particles of the active material and particles of conductive carbon black to at least partly fill the pores of a third partial number of pores which are present in the first section of the electrically nonconductive solid electrolyte material.

In this way, the electrically conducting properties in the first section of the solid electrolyte material are additionally improved, since pores in the first section can be filled with particles of active material, particles of conductive carbon black or with both types of particle. This does not rule out the presence also of a partial number of pores which are filled neither with particles of active material nor with particles of conductive carbon black in the first section.

In an advantageous embodiment of the invention, the electrically nonconductive solid electrolyte material for a secondary electrochemical cell has pores only in sections, i.e., it is pore-free in at least one section. In the pore-free section, the solid electrolyte material has its crystallographic density. In other words, the material is compact in the pore-free section.

The solid electrolyte material thus has sections in which it is porous and at least one section in which it is nonporous, i.e. compact. Scattered, i.e. noncontiguous, pores which remain when, for instance, the material cannot be made compact throughout likewise represent a compact material for the purposes of the present disclosure.

In a particularly preferred embodiment of the invention, an electrode for a secondary electrochemical cell includes such a partly nonporous solid electrolyte material and also an active material, with particles of the active material at least partly filling the pores of a first partial number of pores which are present in the porous section of the electrically nonconductive solid electrolyte material.

A partial number of pores in the porous section of the solid electrolyte material is thus at least partly filled with particles of active material, i.e., an individual filled pore can also be only partly filled with active material. A partial number of pores which are not filled by active material can also remain. The pore-free section of the solid electrolyte material performs both the function of an Li ion conductor and also the function of a separator.

In a preferred further development, an electrode for a secondary electrochemical cell also contains conductive carbon black, with particles of the active material at least partly filling the pores of a first partial number of pores which are present in the porous section of the electrically nonconductive solid electrolyte material, particles of conductive carbon black at least partly filling the pores of a second partial number of pores which are present in the porous section of the electrically nonconductive solid electrolyte material and particles of the active material and of conductive carbon black at least partly filling the pores of a third partial number of pores which are present in the porous section of the electrically nonconductive solid electrolyte material.

For the purposes of the present disclosure, alternatives to conductive carbon black are conductive graphite, carbon nanotubes or other metallic additions such as nanowires.

In the porous section of the solid electrolyte material, the pores can thus be divided into four partial numbers. One partial number of the pores accommodates particles of active material, another partial number accommodates particles of conductive carbon black, a further partial number accommodates particles of active material and of conductive carbon black and the fourth partial number of pores remains unfilled. The partial number of pores containing particles and conductive carbon black is ideally the predominant partial number with a proportion of >90% of the pores.

The invention additionally describes a secondary electrochemical cell which contains a positive electrode having a positive power outlet lead (e.g. aluminum foil), a positive active material and conductive carbon black, contains a negative electrode having a negative power outlet lead (e.g. copper foil) and a negative active material and conductive carbon black and contains, as separator, an electrically nonconductive solid electrolyte material which has pores in a first section and in a third section and is pore-free in a second section which adjoins the first section and the second section. Particles of the negative active material at least partly fill the pores of a first partial number of the pores which are present in the first section of the electrically nonconductive solid electrolyte material. Particles of conductive carbon black at least partly fill the pores of a second partial number of the pores which are present in the first section of the electrically nonconductive solid electrolyte material and particles of the negative active material and of conductive carbon black at least partly fill the pores of a third partial number of the pores which are present in the first section of the electrically nonconductive solid electrolyte material. Particles of the positive active material at least partly fill the pores of a first partial number of the pores which are present in the third section of the electrically nonconductive solid electrolyte material. Particles of conductive carbon black at least partly fill the pores of a second partial number of the pores which are present in the third section of the electrically nonconductive solid electrolyte material and particles of the positive active material and particles of conductive carbon black at least partly fill the pores of a third partial number of the pores which are present in the third section of the electrically nonconductive solid electrolyte material. The pore-free second section of the solid electrolyte material is located between the first section and the third section of the solid electrolyte material.

This forms a secondary electrochemical cell which has an electrically nonconductive solid electrolyte material as separator between the two electrodes. The material serves as Li ion conductor which in each case has pores which are located close to the electrode and in which particles of the respective active material and conductive carbon black are accommodated. Such a secondary cell has minimal ionic transition resistance between active material and electrolyte and also, viewed macroscopically, between composite electrode and separator, since the effective interface between active material and solid electrolyte is extremely large compared to a layer-like or separate arrangement of active material and electrolyte material.

The invention further provides the production of an electrode for a secondary electrochemical cell. A process having the following steps is proposed:
providing a precursor material for an electrically nonconductive solid electrolyte material,
mixing of the precursor material with an electrochemically active material and optionally with electrically conductive material such as conductive carbon black,
homogenization of the mixture of the precursor material and the electrochemically active material,
compaction of the mixture of the precursor material and the electrochemically active material,
sintering of the compacted mixture to give a sintered composite having a plate-like structure or calendering of the compacted mixture to give a calendered composite having a plate-like structure,
application of the precursor material to a first side of the plate-like structure of the sintered or calendered composite and compaction of the precursor material on the plate-like structure of the sintered or calendered composite to give an applied layer of precursor material on the plate-like structure of the sintered or calendered composite,
sintering of the sintered or calendered composite to the applied layer of precursor material,
vapor deposition of a metal foil (vacuum vapor deposition) on a second side of the plate-like structure of the sintered or calendered composite or pressing of the sintered or calendered composite onto a metallic foil as power outlet lead.

The result of the process is an electrode onto the power outlet lead of which an active material firmly joined to solid electrolyte material has been applied, with the solid electrolyte material forming a support matrix for the active material. The active material is incorporated in pores of the solid electrolyte material. The pore diameter is from 10 nm to 50 μm. The electrode is additionally covered with further solid electrolyte material on the side facing away from the power outlet lead, and this further solid electrolyte material has been firmly joined to the solid electrolyte material forming the support matrix by the second sintering operation but does not have any pores. This region or section of the electrolyte material can serve as separator for the electrode when the latter is used in a secondary electrochemical cell.

The invention is based on the following considerations:

All-solid-state lithium or lithium ion cells (ASS-LC) are attractive for use in the automotive field. They are quite safe since in the case of a malfunction of an ASS-LC (for example in the event of a correspondingly serious accident with mechanical, thermal or electrical stress), there is no formation or possible liberation of potentially toxic or combustible species.

Conventional ASS-LCs have, according to the prior art, interfaces between the active material of the positive electrodes and the separator and between the active material of the negative electrode and the separator. The active materials and the separator material typically form plane-parallel layers with corresponding interfaces which are formed essentially in each case by a plane. Such intrinsic interfaces have the disadvantage that they form transition resistances in respect of the lithium (Li) ion conductivity within the cell. The Li ions have to be able to migrate kinetically quickly through the interfaces. Otherwise, transition potentials or overvoltage occur. The transition potentials between electrodes and separator are undesirable since they restrict the reactivity of the cell. As a result, this leads to decreases in power, e.g. during charging and also the high-current behavior generally of the ASS-LC. High charging and discharging powers are, however, a key property of ASS-LCs in automotive applications.

It is therefore proposed according to the invention that inorganic solid materials which conduct Li ions and can function as separator and electrolyte be used in a solid composite with the active materials, in particular the cathodic (positive) active material. Here, the separator is porous in the region of the active material of the electrode, with the pores of the separator, which at the same time performs the function of electrolyte, being filled with particles of the active material and optionally additionally with conductive carbon black. A section of the separator which has either no pores or pores which are not filled with active material and conductive carbon black is present between the two electrodes.

In other words, the active material is embedded in the solid electrolyte material or, as an alternative way of looking at the situation, interstices in the active material are filled with solid electrolyte material. An advantage of such a structure is that, in contrast to a layer structure of active material and separator, the interaction interface between active material and solid electrolyte is enlarged, so that the total resistance to ion conduction is minimized. Li ions can also interact with the solid electrolyte in the “interior” of the active material layer and thus go over from active material into the solid electrolyte material. Within the solid electrolyte material, the Li ions are conducted to the active material respectively having the opposite polarity without leaving the solid structural region of the solid electrolyte material.

Such a structure can also be referred to as functionalized ceramic or hybrid ceramic. The functionalization is by the active material introduced into the pores. To produce such a composite structure of active material and solid electrolyte, it is necessary to create a porous structure in the electrolyte material which is suitable for accommodating active material and/or conductive carbon black. Possible materials for such solid electrolytes are inorganic, ceramic-based separators. Precursors of the solid electrolyte material are for this purpose mixed with active material particles and sintered. A combination of all types of customary active materials, for instance coated transition metal oxides, olivines or spinels (cathodic) and for instance graphite, silicon, metallic lithium, lithium titanate (Li₄Ti₅O₁₂) or carbon materials (anodic), is conceivable.

Structures created in this way ensure low ionic transition resistances during operation of an ASS-LC and thus high electric power and a long life of the ASS-LC. The gravimetric and volumetric power density is in this way increased compared to cells having a layer structure as per the prior art.

A preferred working example of the invention will be described below with the aid of the accompanying drawings. Further details, preferred embodiments and further developments of the invention can be derived therefrom.

### BRIEF DESCRIPTION OF THE DRAWINGS

FIG. 1 shows an electrically nonconductive solid electrolyte having a filled pore region and an unfilled pore region

FIG. 2 shows an electrically nonconductive solid electrolyte having a filled pore region and a pore-free region

FIG. 3 shows a secondary electrochemical cell having a pore region filled with positive active material, a pore region filled with negative active material and a pore-free region located in between.

### DETAILED DESCRIPTION OF THE DRAWINGS

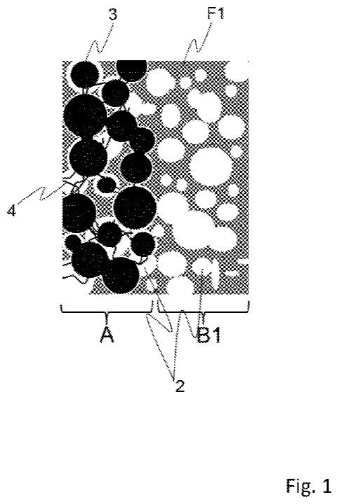

FIG. 1 shows a ceramic solid electrolyte material which has a garnet structure (F1) and pores (2) having a diameter of from 800 nm to 30 μm. The pores in a first region (A) are filled with the positive active material NMC (3) and with conductive carbon black (4), with not all pores being completely filled, if at all. However, a proportion of about 95% of the pores in this section are at least partly filled. In the second region (B1) adjoining the first region (A), the pores are filled neither with active material particles nor with conductive carbon black.

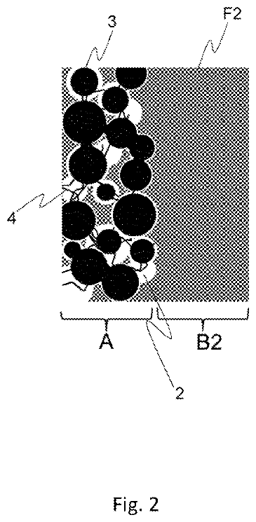

FIG. 2 shows a working example which differs from the working example of FIG. 1 in that the second region (B2) of the solid electrolyte material (F2) adjoining the first region (A) is pore-free.

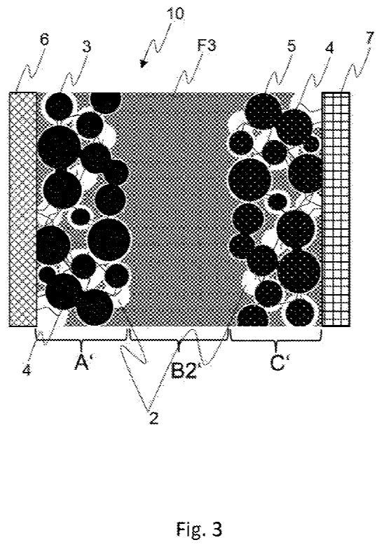

FIG. 3 shows a lithium ion cell (10) having a copper power outlet lead (7) and an aluminum power outlet lead (6). The ceramic solid electrolyte material (F3) serves as separator (B2′) between the negative active material (5) and the positive active material (3). The positive active material together with conductive carbon black (4) fills pores (2) in the solid electrolyte material in a region (A′) close to the aluminum power outlet lead, forming the positive electrode. The negative active material graphite and conductive carbon black fill pores which are present close to the copper power outlet lead in the region (C′), forming the negative electrode. The region (B2′) is pore-free and is present between the regions (A′) and (C′) and performs the function of a separator within the cell.

A further embodiment relates to the process of producing an electrode for a lithium ion cell. The material Li₇La₃Zr₂O₁₂ is selected as solid electrolyte material having a garnet structure. A mixture of lanthanum and zirconium oxide is used as precursor material for the Li₇La₃Zr₂O₁₂. If an electrode used as anode (negative electrode), e.g. in an Li ion cell, is being produced, synthetic graphite comes into consideration. If an electrode used as cathode (positive electrode), e.g. in an Li ion cell, is being produced, NMC111 comes into consideration. For this purpose, about 34 g of the precursor material having an average particle diameter of 0.1 μm and about 98 g of NMC111 having an average particle diameter of 9 μm are mixed with about 3 g of conductive carbon black and compacted. For the sintering operation under a nitrogen atmosphere, the temperature is brought to about 400-1200° C. over a period of about 24 hours under isostatic pressure. Under these conditions, the ceramic solid electrolyte material having a garnet structure remains stable. Subsequently, about 50 g of the Li₇La₃Zr₂O₁₂ precursor material are applied to one side of the sintered structure, compacted and sintered using the above parameters. This gives an electrode structure as depicted in FIG. 2. In the case of production of a cathode by the method of this example, aluminum as power outlet lead material is then also vapor-deposited in the form of a foil. Vaporization is preferably carried out using a vacuum vaporizer having a melt tank temperature in the region of the melting point of aluminum and a vacuum of from 10⁻³ mbar to 1 mbar.

Alternative solid electrolyte materials for other embodiments are perovskites, sulfides and oxides in addition to the garnets. Particularly useful structures are those derived from LISICON (lithium (Li) super (S) ionic (I) conductor (CON)), for example thio-LISICON Li₄₋ₓM_{1-y}M′_{y}S₄ where M=Si, Ge, P, and M′=P, Al, Zn, Ga, Sb, or NASISCON (sodium (Na) super (S) ionic (I) conductor (CON)) of the general formula AMM′P₃O₁₂, where A=Li⁺, Na⁺, K⁺, Rb⁺, Cs⁺, Mg²⁺, Ca²⁺, Sr²⁺, Ba²⁺, H⁺, H₃O⁺, NH⁴⁺, Cu⁺, Ag⁺, Pb²⁺, Cd²⁺, Mn²⁺, Co²⁺, Mn²⁺, Co²⁺, Ni²⁺, Zn²⁺, Al³⁺, Ln³⁺, Ge⁴⁺, Zr⁴⁺, Hf⁴⁺ or unoccupied, M and M′=divalent, trivalent, tetravalent or pentavalent transition metal ions selected from the group consisting of Zn²⁺, Cd²⁺, Ni²⁺, Mn²⁺, Co²⁺, Fe³⁺, Sc³⁺, Ti³⁺, V³⁺, Al³⁺, In³⁺, Ga³⁺, Y³⁺, Lu³⁺, Ti⁴⁺, Zr⁴⁺, Hf⁴⁺, Sn⁴⁺, Si⁴⁺, V⁵⁺, Nb⁵⁺, Ta⁵⁺, Sb⁵⁺, As⁵⁺, where phosphorus can also be partly replaced by Si or As.

1-10. (canceled)

11. An electrically nonconductive solid electrolyte material for a secondary electrochemical cell, wherein
the solid electrolyte material has pores.

12. An electrically nonconductive solid electrolyte material for a secondary electrochemical cell, wherein
the solid electrolyte material has pores in first sections and
the solid electrolyte material is pore-free in second sections.

13. The electrically nonconductive solid electrolyte material according to claim 11, wherein
the diameter of the pores is from 10 nm to 50 μm.

14. The electrically nonconductive solid electrolyte material according to claim 12, wherein
the diameter of the pores is from 10 nm to 50 μm.

15. An electrode for a secondary electrochemical cell, wherein
the electrode comprises an active material,
the electrode comprises an electrically nonconductive solid electrolyte material according to claim 11,
particles of the active material at least partially fill pores of a first partial number of pores which are present in a first section of the electrically nonconductive solid electrolyte material, and
pores which are present in a second section of the electrically nonconductive solid electrolyte material are unfilled.

16. An electrode for a secondary electrochemical cell, wherein
the electrode comprises an active material,
the electrode comprises an electrically nonconductive solid electrolyte material according to claim 13,
particles of the active material at least partially fill pores of a first partial number of pores which are present in a first section of the electrically nonconductive solid electrolyte material, and
pores which are present in a second section of the electrically nonconductive solid electrolyte material are unfilled.

17. The electrode for a secondary electrochemical cell according to claim 15, wherein
the electrode comprises conductive carbon black,
particles of conductive carbon black at least partly fill pores of a second partial number of pores which are present in the first section of the electrically nonconductive solid electrolyte material, and
particles of the active material and particles of conductive carbon black at least partly fill pores of a third partial number of pores which are present in the first section of the electrically nonconductive solid electrolyte material.

18. An electrode for a secondary electrochemical cell, wherein
the electrode comprises an active material,
the electrode comprises an electrically nonconductive solid electrolyte material according to claim 12, and
particles of the active material at least partly fill pores of a first partial number of pores which are present in the first section of the electrically nonconductive solid electrolyte material.

19. An electrode for a secondary electrochemical cell, wherein
the electrode comprises an active material,
the electrode comprises an electrically nonconductive solid electrolyte material according to claim 14, and
particles of the active material at least partly fill pores of a first partial number of pores which are present in the first section of the electrically nonconductive solid electrolyte material.

20. The electrode for a secondary electrochemical cell according to claim 18, wherein
the electrode comprises conductive carbon black,
particles of conductive carbon black at least partially fill pores of a second partial number of pores which are present in the first section of the electrically nonconductive solid electrolyte material, and
particles of the active material and particles of conductive carbon black at least partly fill pores of a third partial number of pores which are present in the first section of the electrically nonconductive solid electrolyte material.

21. A secondary electrochemical cell comprising:
a positive electrode having a first power outlet lead and a positive active material,
a negative electrode having a second power outlet lead and a negative active material,
and conductive carbon black,
wherein
the secondary electrochemical cell comprises an electrically nonconductive solid electrolyte material as a separator,
the electrically nonconductive solid electrolyte material has pores in first sections,
the electrically nonconductive solid electrolyte material is pore-free in at least one second section,
particles of the positive active material at least partly fill pores of a first partial number of pores which are present in the first section of the electrically nonconductive solid electrolyte material,
particles of conductive carbon black at least partly fill pores of a second partial number of pores which are present in the first section of the electrically nonconductive solid electrolyte material,
particles of the positive active material and particles of conductive carbon black at least partly fill pores of a third partial number of pores which are present in the first section of the electrically nonconductive solid electrolyte material,
particles of the negative active material at least partly fill pores of a fourth partial number of pores which are present in the first section of the electrically nonconductive solid electrolyte material,
particles of conductive carbon black at least partly fill pores of a fifth partial number of pores which are present in the first section of the electrically nonconductive solid electrolyte material, and
particles of the negative active material and particles of conductive carbon black at least partly fill pores of a sixth partial number of pores which are present in the first section of the electrically nonconductive solid electrolyte material.

22. A process for producing an electrode for a secondary electrochemical cell, comprising the steps of:
providing a precursor material for an electrically nonconductive solid electrolyte material,
mixing the precursor material with an electrochemical active material,
compacting the mixture of the precursor material and the electrochemical active material,
sintering the compacted mixture of the precursor material and the electrochemical active material to give a sintered composite having a plate-like structure,
applying the precursor material to a first side of the plate-like structure and compacting the precursor material on the plate-like structure to give an applied layer of precursor material on the plate-like structure,
sintering of the plate-like structure and the applied layer of precursor material, and
vapor-depositing of a metal foil on a second side of the plate-like structure.
